(19) United States
(12) Patent Application Publication
(10) Pub. No.: US 2022/0392001 A1
(43) Pub. Date: Dec. 8, 2022

(54) GUARDIAN INFORMATION-BASED ANIMAL INTEGRATED MANAGEMENT SERVER AND ANIMAL INTEGRATED MANAGEMENT METHOD THEREOF

(71) Applicant: HUMANIZONE CO., LTD., Seoul (KR)

(72) Inventors: Jong Ho PARK, Seoul (KR); Jin Hyun BAEK, Seoul (KR)

(21) Appl. No.: 17/820,463

(22) Filed: Aug. 17, 2022

Related U.S. Application Data
(63) Continuation of application No. PCT/KR2021/002064, filed on Feb. 18, 2021.

(30) Foreign Application Priority Data
Feb. 19, 2020 (KR) 10-2020-0020114

(51) Int. Cl. G06Q 50/10; G06Q 30/02

(52) U.S. Cl. CPC G06Q 50/10; G06Q 30/0207

(57) ABSTRACT

A guardian information-based animal integrated management server is proposed. The server may include a guardian information receiver receiving guardian information including at least one of a name, address, birth date, and sex of a guardian, and an animal receiver receiving animal information including at least one of a type, sex, photograph, and birth date of an animal corresponding to the guardian. The server may also include an electronic gift certificate providing processor providing an electronic gift certificate including at least one of a medical treatment and vaccination for the animal. The server may further include a medical treatment information receiver receiving medical treatment information regarding at least one of a medical treatment, surgery, vaccination, and prescription for the animal, and a medical treatment history managing processor matching a medical treatment history of the animal with the guardian information according to the received medical treatment information, and managing same.

### CROSS REFERENCE TO RELATED APPLICATIONS

This is a continuation application of International Patent Application No. PCT/KR2021/002064, filed on Feb. 18, 2021, which claims priority to Korean patent application No. 10-2020-0020114 filed on Feb. 19, 2020, contents of both of which are incorporated herein by reference in their entireties.

### BACKGROUND

### Technical Field

The present disclosure relates to an integrated animal management server and an integrated animal management method thereof, and more particularly, to a guardian information-based integrated animal management server for not only rapidly identifying animals without implanting microchips in the animals in the event of adoption or development of genetic disorders or diseases in companion animals such as dogs or cats, livestock including cattle and pigs and animals kept by owners such as parrots and turtles, but also providing various products or services for the animals in an integrated manner and systematically managing the animals, and an integrated animal management method thereof.

### Description of Related Technology

Recently, as the percentages of households owning pet animals increase very fast, pet animals are simply not an animal and they are perceived as very precious existence as companion animals. Accordingly, guardians visit beauty salons for companion animals to get the companion animals groomed and animal hospitals to prevent or treat disorders or diseases of the companion animals, supply high quality food to keep the companion animals healthy or spend a lot of time in walking and exercising with the companion animals.

### SUMMARY

One aspect is a guardian information-based integrated animal management server for not only rapidly identifying animals without implanting microchips in the animals in the event of adoption or development of genetic disorders or diseases in companion animals such as dogs or cats, livestock including cattle and pigs and animals kept by owners such as parrots and turtles, but also providing various products or services for the animals in an integrated manner and systematically managing the animals and an integrated animal management method thereof.

Another aspect is a guardian information-based integrated animal management server that includes a guardian information receiving unit configured to receive guardian information including at least one of a name, an address, a birthday or a gender of a guardian; an animal receiving unit configured to receive animal information including at least one of a type, a gender, a picture or a birthday of an animal corresponding to the guardian; an electronic gift certificate providing unit configured to provide the guardian with an electronic gift certificate including at least one of treatment or vaccination for the animal corresponding to the received animal information; a medical information receiving unit configured to receive medical information about at least one of treatment, surgery, vaccination or prescription for the animal corresponding to the provided electronic gift certificate; a medical history management unit configured to manage a medical history of the animal by matching it with the guardian information according to the received medical information; and an identification code assigning unit configured to assign an identification code to each of the guardian and the animal, wherein when the number of animals corresponding to the guardian is more than one, the identification code assigning unit assigns different identification codes to the animals, wherein when at least one of the animals having relationship of a father, mother, older brother, younger brother, older sister or younger sister is adopted, the identification code assigning unit assigns a new identification code to an adopter, and the medical history management unit manages an identification code of the adopted animal by matching it with the identification code assigned to the guardian and the identification code assigned to the adopter, together with the identification code assigned to at least one of the father, mother, older brother, younger brother, older sister or younger sister of the adopted animal.

The integrated animal management server may further include a product information receiving unit configured to receive product information from a seller who sells a product including at least one of an insurance product, a vaccine product, a beauty product or a feed product for the animal; a relevance analysis unit configured to, when the guardian purchases at least one product in the received product information, analyze a relevance between the animal information of the animal corresponding to the guardian and the purchased product; and an analysis information providing unit configured to provide the seller with analysis information analyzed by the relevance analysis unit for a set period of time.

The integrated animal management server may further include a service information storing unit configured to store service information including a service area and a service time of at least one service of an animal hotel, a pet beauty shop or a pet sitter, a selection menu providing unit configured to the guardian with a selection menu for the stored service information; and an electronic code providing unit configured to, when the guardian selects the service information corresponding to the provided selection menu, provide an electronic code for subtracting money corresponding to the selected service information from money paid by the guardian.

Another aspect is an integrated animal management method that includes receiving guardian information including at least one of a name, an address, a birthday or a gender of a guardian; receiving animal information including at least one of a type, a gender, a picture or a birthday of an animal corresponding to the guardian; assigning an identification code to each of the guardian and the animal, wherein when the number of animals corresponding to the guardian is more than one, different identification codes are each assigned to each of the animals; providing the guardian with an electronic gift certificate including at least one of treatment or vaccination for the animal corresponding to the received animal information; receiving medical information about at least one of treatment, surgery, vaccination or prescription for the animal corresponding to the provided electronic gift certificate; and managing a medical history of the animal by matching it with the guardian information according to the received medical information, wherein when at least one of the animals having relationship of a father, mother, older brother, younger brother, older sister or younger sister is adopted, the assigning of the identification code comprises assigning a new identification code to an adopter, and the managing of the medical history comprises managing an identification code of the adopted animal by matching it with the identification code assigned to the guardian and the identification code assigned to the adopter, together with the identification code assigned to at least one of the father, mother, older brother, younger brother, older sister or younger sister of the adopted animal.

The integrated animal management method may further include receiving and storing product information of a product including at least one of an insurance product, a vaccine product, a beauty product or a feed product for the animal; when the guardian purchases at least one product in the stored product information, analyzing a relevance between the animal information of the animal corresponding to the guardian and the purchased product; and providing the seller corresponding to the received product information with analysis information analyzed by the relevance analysis step for a set period of time.

The integrated animal management method may further include storing service information including a service area and a service time of at least one product of an animal hotel, a pet beauty shop or a pet sitter; providing the guardian with a selection menu for the stored service information; and when the guardian selects the service information corresponding to the provided selection menu, providing an electronic code for subtracting money corresponding to the selected service information from money paid by the guardian.

According to the present disclosure, it is possible to rapidly identify animals without implanting microchips in the animals in the event of adoption or development of genetic disorders or diseases.

Additionally, according to the present disclosure, it is possible to provide various products or services for animals in an integrated manner and systematically manage the animals.

### BRIEF DESCRIPTION OF THE DRAWINGS

FIG. 1 is a diagram schematically showing a system to which a guardian information-based integrated animal management server according to an embodiment of the present disclosure is applied.

FIG. 2 is a diagram schematically showing the configuration of the integrated animal management server shown in FIG. 1.

FIG. 3 is a diagram illustrating an example for managing histories of animals.

FIG. 4 is a diagram illustrating an example of searching for veterinarians by a guardian.

FIG. 5 is a diagram illustrating an example of providing a guardian with veterinarian information including a treatment area and an available time of a veterinarian.

FIG. 6 is a diagram illustrating an example of chatting via a communication channel built between a guardian and a veterinarian.

FIG. 7 is a diagram illustrating an example of providing animal information associated with an animal.

FIG. 8 is a diagram illustrating an example of providing a guardian with selection menus of available services for an animal.

FIG. 9 is a diagram illustrating animal products sales on behalf.

FIG. 10 is a diagram illustrating holding a pet exhibition.

FIGS. 11 and 12 are flowcharts showing an integrated animal management method according to an embodiment of the present disclosure.

### DETAILED DESCRIPTION

The Korean Animal Protection Act stipulates “an owner of an animal subject to registration shall register the animal subject to registration with the head of Si/Gun/Gu (the head of autonomous Gu. the same below)/Special Self-Governing City mayor (hereinafter referred to as “head of Si/Gun/Gu”) to protect the animal and prevent loss/abandonment”. Here, the animal subject to registration is an animal deemed necessary to register to protect the animal, prevent loss/abandonment, manage disorders or diseases and prevent risks to public health, and refers to a dog kept in house/quasi-house and a dog kept in other places than house/quasi-house for companionship.

However, in recent years, companion animals are not limited to dogs and extend to various types of animals such as cats, rabbits, turtles and parrots, but the current legal companion animal management regulations are based on dogs, and do not apply to other animals such as cats, rabbits, turtles and parrots in an integrated manner.

Additionally, the common animal management has been primarily done by implanting microchips in animals or attaching identification devices to animals, but implanting microchips in animals may cause reluctance or side effects to the animals and many zoophilists present opposition and guardians tend to avoid, and attaching identification devices to animals loses operational effectiveness when the corresponding identification devices are separated from the animals.

Additionally, in case that there are changes in guardians by the adoption of animals, the common animal management method fails to identify their history at once.

Additionally, in case that animals have genetic disorders or diseases, the common animal management method fails to identify the fact that the disorders or diseases are genetic disorders or diseases at once, and even though the fact is known, has limitations in taking actions.

Hereinafter, some embodiments of the present disclosure will be described through the exemplary drawings. It should be noted that in adding the reference signs to the elements of each drawing, like reference signs denote like elements as possible even though they are indicated on different drawings. Additionally, in describing the embodiments of the present disclosure, when a certain detailed description of relevant known elements or functions is determined to hinder the understanding of the embodiments of the present disclosure, the detailed description is omitted.

Additionally, in describing the elements of the embodiments of the present disclosure, the terms ‘first’, ‘second’, A, B, (a), (b) and the like may be used. These terms are only used to distinguish one element from another, and the nature of the corresponding element or its sequence or order is not limited by the term. It should be understood that when an element is referred to as being “connected”, “coupled” or “linked” to another element, it can be directly connected or linked to other element, but intervening elements may be “connected”, “coupled” or “linked” between each element.

### MODE FOR DISCLOSURE

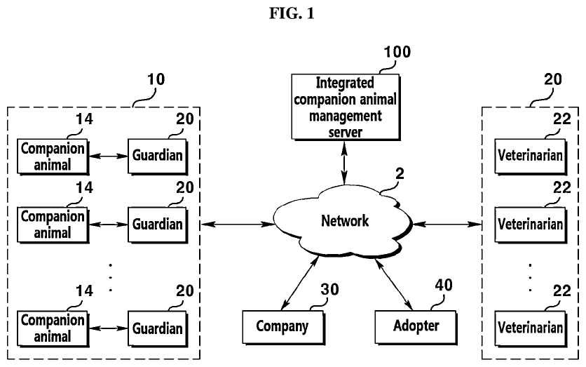

FIG. 1 is a diagram schematically showing a system to which a guardian information-based integrated animal management server according to an embodiment of the present disclosure is applied.

Referring to FIG. 1, the integrated animal management server 100 according to an embodiment of the present disclosure may be connected to a terminal of at least one guardian 12, a terminal of at least one veterinarian 22, a terminal of a company 30 and a terminal of an adopter 40, via a network 2.

Here, the guardian 12 is a person who owns an animal 14, and refers to a member who signed up an integrated animal management service according to an embodiment of the present disclosure to receive the integrated management service for the animal 14. Additionally, the animal 14 is an animal kept by the guardian 12, and may include dogs, cats and any other types of animals. In this instance, the integrated animal management server 100 may group guardians who signed up the integrated animal management service according to an embodiment of the present disclosure and manage together with the animal 14 corresponding to each guardian in a guardian database 10.

The veterinarian 22 is a medical professional who protects the health, environment, hygiene of animals and prevents and treats various disorders or diseases including zoonotic diseases, and refers to a medical professional registered in the integrated animal management service according to an embodiment of the present disclosure. In this instance, the integrated animal management server 100 may group veterinarians registered in the integrated animal management service according to an embodiment of the present disclosure and manage in a veterinarian database 20.

The company 30 includes service providers who provide services, for example, hotels, grooming and pet sitters for the animal 14 and sellers who manufacture/sell various products including insurance products, vaccine products, beauty products and feed products for the animal 14. In this instance, the integrated animal management server 100 may manage various companies registered in the integrated animal management service according to an embodiment of the present disclosure in a company database.

The adopter 40 is a person who wants to adopt the animal 14 from the guardian 12, and may sign up the integrated animal management service as a member according to an embodiment of the present disclosure and receive animal information of the animal 14 that the adopter 40 wants to adopt.

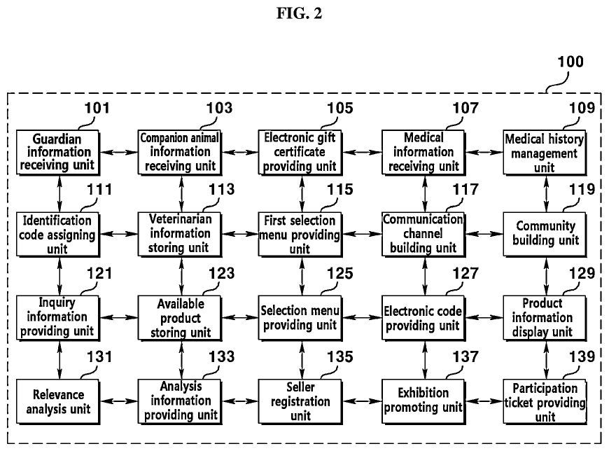

FIG. 2 is a diagram schematically showing the configuration of the integrated animal management server shown in FIG. 1.

Referring to FIG. 2, the integrated animal management server 100 according to an embodiment of the present disclosure may include a guardian information receiving unit (or a guardian information receiver) 101, an animal information receiving unit (or an animal information receiver) 103, an electronic gift certificate providing unit (or an electronic gift certificate providing processor) 105, a medical information receiving unit (or a medical information receiver) 107, a medical history management unit (or a medical history management processor) 109, an identification code assigning unit (or an identification code assigning processor) 111, a veterinarian information storing unit (or a veterinarian information memory) 113, a first selection menu providing unit (a first selection menu providing processor) 115, a communication channel building unit (a communication channel building processor) 117, a community building unit (or a community building processor) 119, an inquiry information providing unit (or an inquiry information providing processor) 121, a service information storing unit (or a service information memory) 123, a second selection menu providing unit (or a second selection menu providing processor) 125, an electronic code providing unit (or an electronic code providing processor) 127, a product information receiving unit (a product information receiver) 129, a relevance analysis unit (or a relevance analysis processor) 131, an analysis information providing unit (or an analysis information providing processor) 133, a seller registration unit (or a seller registration processor) 135, an exhibition promoting unit (or an exhibition promoting processor) 137 and a participation ticket providing unit (or a participation ticket providing processor) 139.

The guardian information receiving unit 101 receives guardian information including at least one of name, address, birthday or gender of a guardian. That is, the guardian information receiving unit 101 may receive the guardian information, for example, the name, address, birthday and gender of the guardian 12 who signed up the integrated animal management service according to an embodiment of the present disclosure from the corresponding guardian 12, and register the received guardian information. In this instance, the guardian information receiving unit 101 may perform, for the guardian 12, an authentication procedure on the received guardian information through certificate-based authentication or mobile authentication.

The animal receiving unit 103 receives animal information including at least one of type, gender, picture or birthday of the animal 14 corresponding to the guardian 12. For example, the animal receiving unit 103 may receive animal type information of the animal 14 corresponding to the guardian 12, for example, a dog, a cat or any other type of animal. Additionally, the animal receiving unit 103 may receive breed information in the animal type information of the animal 14. For example, when the animal 14 is a dog, the animal receiving unit 103 may receive information about which the corresponding animal 14 is Maltese, Pomeranian or Chihuahua. Additionally, the animal receiving unit 103 may receive information about gender, picture, color, physical features, name called by the guardian 12 and birthday of the animal 14.

The electronic gift certificate providing unit 105 provides the guardian 12 with an electronic gift certificate including at least one of treatment or vaccination for the animal 14 corresponding to the received animal information. In this instance, the electronic gift certificate providing unit 105 may receive a preset membership fee from the guardian 12 who signed up the integrated animal management service according to an embodiment of the present disclosure, and in exchange for the membership fee, may provide an electronic gift certificate that can be used to purchase services, for example, treatment, vaccination, grooming, pet sitters and staying in animal hotels for the animal 14, or products, for example, feeds, toys, beauty products and medications.

The medical information receiving unit 107 receives medical information about at least one of treatment, surgery, vaccination or prescription for the animal corresponding to the electronic gift certificate provided to the guardian 12. That is, when the guardian 12 has treatment, surgery, vaccination and prescription for the animal 14 from the veterinarian 22 using the electronic gift certificate received from the electronic gift certificate providing unit 105, the medical information receiving unit 107 receives the medical information about the treatment, surgery, vaccination and prescription conducted on the corresponding animal 14 from the veterinarian 22. In this instance, the medical information receiving unit 107 may receive the medical information including information about the physical features of the corresponding animal 14 and particular features of the surgery or treatment from the veterinarian 22.

The medical history management unit 109 manages a medical history of the animal 14 by matching it with the guardian information according to the received medical information. That is, when the medical information of the animal 14 is received from the terminal of the veterinarian 22 via the network 2, the medical history management unit 109 manages the corresponding medical information by matching it with the guardian information of the guardian 12.

The identification code assigning unit 111 assigns an identification code to each of the guardian 12 and the animal 14 corresponding to the guardian 12. In this instance, when the number of animals corresponding to the guardian 12 is more than one, the identification code assigning unit 111 assigns different identification codes to each animal. Additionally, in case that the animal is adopted, the identification code assigning unit 111 assigns a new identification code to the adopter.

In this instance, the medical history management unit 109 matches the identification code assigned to the previous guardian and the identification code assigned to the adopter with the identification code assigned to the animal 14 and manages the same. Additionally, when the number of animals 14 owned by the guardian 12 is more than one and each animal 14 has relationship of a father, mother, older brother, younger brother, older sister or younger sister, the medical history management unit 109 matches the identification code assigned to each animal 14, the identification code of the animal 14 having relationship of a father, mother, older brother, younger brother, older sister or younger sister and the identification code assigned to the guardian 12 and manages the same.

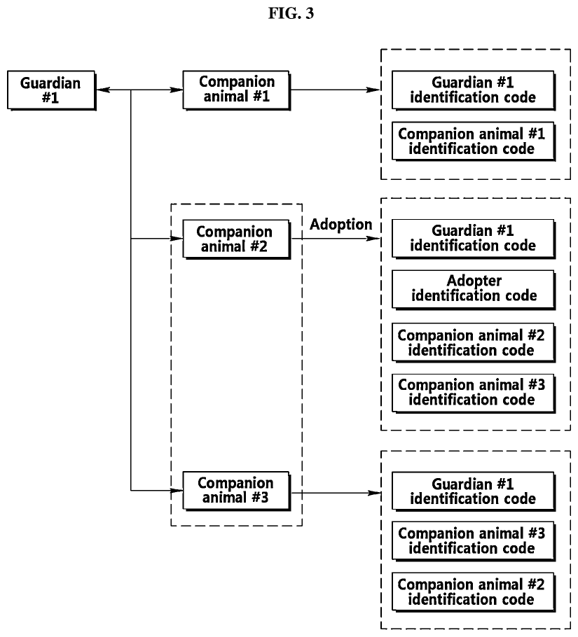

For example, as shown in FIG. 3, when guardian 1 owns animal 1, animal 2 and animal 3, and animal 2 and animal 3 have relationship of a father, mother, older brother, younger brother, older sister or younger sister, the medical history management unit 109 may, for animal 1, march the identification code of guardian 1 with the identification code of animal 1 and manage the same, and for each of animal 2 and animal 3, match the identification code of guardian 1, the identification code of the corresponding animal (animal 2 or animal 3) and the identification code of the other animal (for animal 2, animal 3, and for animal 3, animal 2) in relationship of a father, mother, older brother, younger brother, older sister or younger sister and manage the same. In this instance, when the adopter adopts animal 2 among animal 2 and animal 3 in relationship of a father, mother, older brother, younger brother, older sister or younger sister, the medical history management unit 109 may, for animal 2, match the identification code of the previous guardian 1, the identification code of the adopter, the identification code of animal 2 and the identification code of animal 3 and manage the same. As described above, when the animal is adopted from any one guardian to another guardian, the guardian information-based integrated animal management server 100 according to an embodiment of the present disclosure may clearly identify an adoption history of the corresponding animal by matching the identification code of the previous guardian and the identification code of the adopter together with the identification code of the corresponding animal and managing the same. Additionally, since the guardian information-based integrated animal management server 100 according to an embodiment of the present disclosure manages the identification code of any one animal together with the identification code of the animal in relationship of a father, mother, older brother, younger brother, older sister or younger sister with the corresponding animal, in case that the animal in relationship of a father, mother, older brother, younger brother, older sister or younger sister is adopted by another guardian, it is possible to identify the adopter through the identification code of the adopted animal, and ensure rapid cooperation between the animals in relationship of a father, mother, older brother, younger brother, older sister or younger sister when the animal has genetic disorders or diseases.

The veterinarian information storing unit 113 stores veterinarian information including at least one of a treatment area (a location of an animal hospital) or an available time of the registered veterinarian 22. In this instance, in addition to the treatment area and the available time of the registered veterinarian 22, the veterinarian information storing unit 113 may store the veterinarian information about the career of the corresponding veterinarian 22, and the type of animal and the type of disorder or disease that the veterinarian 22 specializes.

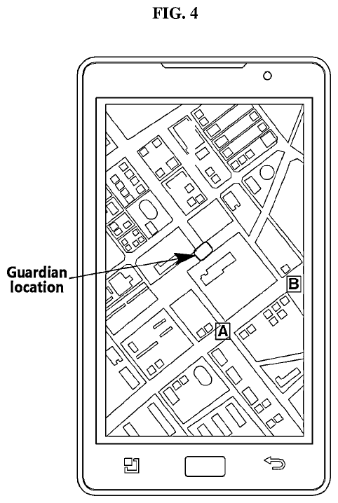

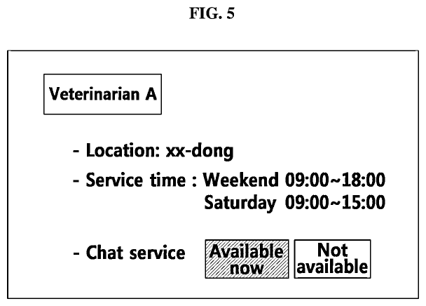

The first selection menu providing unit 115 provides the guardian 12 with a selection menu for the veterinarian information. In this instance, as shown in FIG. 4, the first selection menu providing unit 115 may classify the veterinarian information of the registered veterinarian 22 according to the treatment area and display in the order of distance from the address or the current location of the guardian 12. In this case, when each veterinarian information is selected, the first selection menu providing unit 115 may display its corresponding transportation information, and the time it takes to walk from the current location of the guardian 12. Through this, when an emergency situation happens to the animal 14, the guardian 12 may search for the veterinarian 22 near the current location of the guardian 12 to obtain rapid treatment for the animal 14. Additionally, the first selection menu providing unit 115 may classify the veterinarian information of the registered veterinarian 22 according to the type of animal and the type of disorder or disease that the veterinarian 22 specializes in the treatment, and provide the corresponding selection menu. In this instance, when the guardian 12 selects any one veterinarian information corresponding to the provided selection menu, the first selection menu providing unit 115 may display detailed information of the selected veterinarian information. In this case, as shown in FIG. 5, the first selection menu providing unit 115 may also display whether or not the veterinarian 22 corresponding to the selected veterinarian information can build a communication channel now.

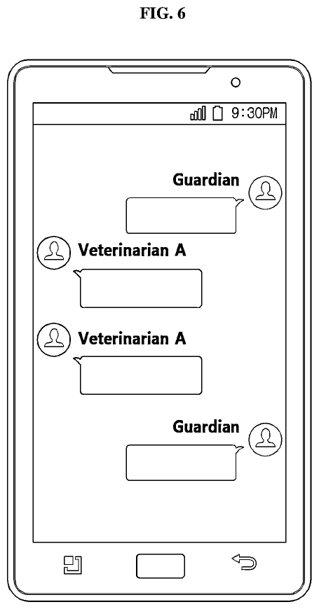

When the guardian 12 requests to build the communication channel with the corresponding veterinarian 22 based on the selected veterinarian information, the communication channel building unit 117 builds the communication channel between the veterinarian 22 corresponding to the selected veterinarian information and the guardian 12. In this instance, as shown in FIG. 6, the communication channel building unit 117 may build the communication channel for chatting between the guardian 12 and the veterinarian 22 to allow the guardian 12 to ask the likelihood of developing disorders or diseases caused by symptoms or conditions of the animal 14 and receive an appropriate and rapid response from the veterinarian 22. Although it is illustrated and described that the communication channel building unit 117 builds the communication channel for chatting, in addition to the chatting channel, the communication channel building unit 117 may build various communication channels including an audio channel and a video channel.

The community building unit 119 may build a community with at least one other registered guardian in response to the request from the guardian 12 or induce participation in a built community. In this instance, to make it easy to build the community, the community building unit 119 may disclose information, for example, the types of animals of the guardians registered as members, the number of members corresponding to each type, the breed of each animal and the number of members corresponding to each breed, to guardians registered as members. Additionally, the community building unit 119 may disclose information, for example, the types of animals and the breeds of animals in the built community. For example, in the case of the community for guardians who own a specific breed of pet dog, the community building unit 119 may make information accessible to the members, for example, the breed of the corresponding pet dog and the number of members in the community, to allow the guardian 12 who owns the animal 14 of the same breed to exchange opinions about treatment, vaccination and grooming for each animal 14 with the other members.

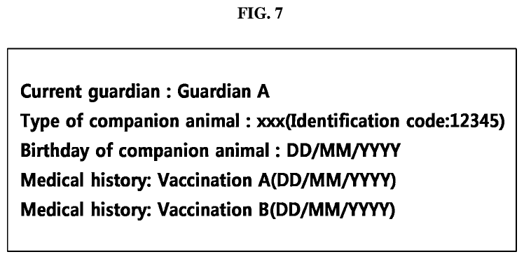

When a request for inquiry about the specific animal 14 is received from a third party, the inquiry information providing unit 121 provides the third party with inquiry information including the animal information and the medical history of the corresponding animal 14. For example, when the specific guardian 12 wants to participate in the community built by the community building unit 119, the corresponding community manager may request to inquire about the animal 14 of the specific guardian 12 who wants to participate, and in this case, the inquiry information providing unit 121 may provide the corresponding community manager with the inquiry information including guardian, type, breed, birthday and medical history of the animal 14 of the specific guardian 12 as shown in FIG. 7. Additionally, the adopter who wants to adopt the animal 14 from the specific guardian 12 may request to inquire about the corresponding animal 14, and in this case, the inquiry information providing unit 121 may provide the adopter with the animal information and the medical history of the animal 14 of the specific guardian 12. Here, the third party may include a person who is a non-member of the integrated animal management service according to an embodiment of the present disclosure but obtains consent from the guardian 12 or has formal qualification, other than the person who signed up the integrated animal management service according to an embodiment of the present disclosure as a member and the registered veterinarian. In this instance, when the inquiry information providing unit 121 provides the third party with the animal information of the specific guardian, the inquiry information providing unit 121 may allow the third party to see only brief information such as ID and name of the specific guardian, and may encode or omit personal information of the specific guardian. Through this, the integrated animal management server 100 according to an embodiment of the present disclosure allows the members to check the animal information and the medical history of the animal freely, thereby verifying the authenticity of the animal of the member who wants to participate in the specific community and checking treatment and vaccination in the case of fostering or adoption of the animal between the members.

The service information storing unit 123 stores service information including a service area and a service time of at least one service of animal hotel, pet beauty shop or pet sitter. That is, the service information storing unit 123 classifies and stores the service information including the service area and the service time of the company that offers the service such as animal hotel, pet beauty shop and pet sitter among the companies 30 registered in the integrated animal management service according to an embodiment of the present disclosure. Although it is described that the service information storing unit 123 stores the information about the animal hotel, pet beauty shop and pet sitter as the service information for the animal, the service information storing unit 123 may store the service information of various services for the animal 14.

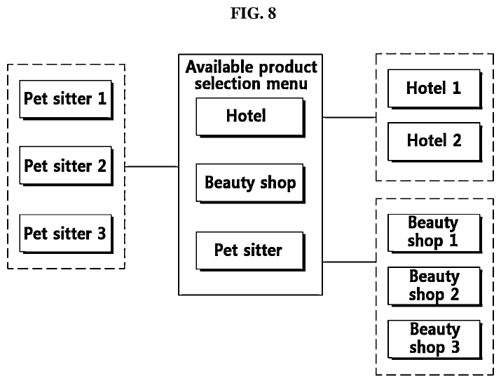

The second selection menu providing unit 125 provides the guardian 12 with a selection menu for the stored service information. In this instance, as shown in FIG. 8, the second selection menu providing unit 125 may provide the service type stored in the service information storing unit 123 as the selection menu and each service corresponding to the selected service type as an additional selection menu. In this case, each additional selection menu may be classified according to the service company and the service area of the corresponding service.

When the guardian 12 selects the service information corresponding to the selection menu provided by the second selection menu providing unit 125, the electronic code providing unit 127 provides an electronic code corresponding to the selected service information. In this instance, the electronic code providing unit 125 may subtract money corresponding to the selected service information from money paid by the guardian 12 when signing up or additional money paid, and provide balance information to the guardian 12. Additionally, the electronic code providing unit 127 may provide the electronic code available for any service anywhere irrespective of area and service by the selection of the guardian 12 or the electronic code available only for a designated specific service.

The product information receiving unit 129 receives product information from the seller who sells the product including at least one of insurance product, vaccine product, beauty product or feed product for the animal 14. That is, the product information receiving unit 129 receives the product information of the product dealt with by the seller or manufacturer from the corresponding seller or manufacturer who deals with the product, for example, the insurance product, vaccine product, beauty product and feed product for the animal among the registered companies 30. In this instance, the product information receiving unit 129 may display the product information received from the seller or manufacturer on a web page to allow the guardian 12 to purchase the displayed product.

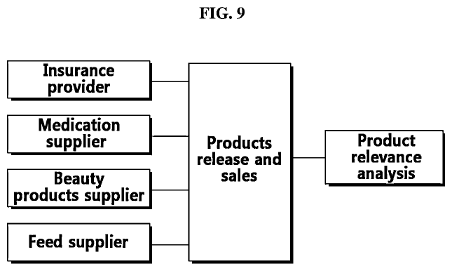

When the guardian 12 purchases at least one product in the displayed product information, the relevance analysis unit 131 analyzes the relevance between the animal information of the animal corresponding to the guardian 12 and the purchased product. In this instance, as shown in FIG. 9, the relevance analysis unit 131 may sell each product corresponding to the product information received from the insurance provider, medication supplier, beauty products supplier and feed supplier on behalf, record the type, breed, gender and birthday of the animal corresponding to the guardian 12 who purchased for each product, accumulate data recorded for each product purchased for a set period of time, and analyze the number of sales for each product, the time at which the specific product is sold, and the gender and age of the animal for which the specific product is popular, according to the type, breed, gender and birthday of the animal, through the accumulated data.

The analysis information providing unit 133 provides the seller or manufacturer with the analysis information analyzed by the relevance analysis unit 131 for the set period of time. That is, the analysis information providing unit 133 provides the analysis information about the number of sales of the product for the set period of time and the type, breed, gender and birthday of the animal 14 of the guardian 12 who usually purchases the product for each product corresponding to the product information received from the seller or manufacturer. Through this, the manufacturer or seller of the product may gradually create advanced sales strategies and improvement measures for his/her product.

The seller registration unit 135 registers the seller or manufacturer who sells the product or service for the animal 14. That is, the seller registration unit 135 registers information about the companies 30 registered in the integrated animal management service according to an embodiment of the present disclosure, for example, the product or service for the animal 14 and each seller or manufacturer, in an integrated manner.

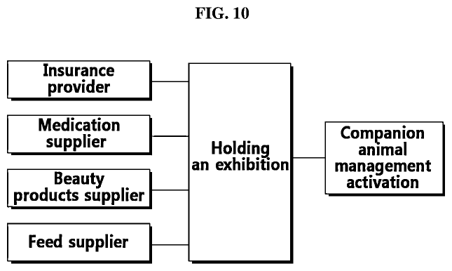

The exhibition promoting unit 137 plans an exhibition for the animal 14, and promotes the planned exhibition. That is, as shown in FIG. 10, the exhibition promoting unit 137 holds the exhibition in which the insurance provider, medication supplier, beauty products supplier, feed supplier and pet beauty shop may participate, to promote the sales of the product or service of the insurance provider, medication supplier, beauty products supplier, feed supplier and pet beauty shop who participates in the exhibition and help the guardian 12 who participates in the exhibition to manage the animal 14 to look better and be healthier, thereby activating animal management. In this instance, the exhibition promoting unit 137 may transmit the event duration and details of the planned exhibition and benefits for the animal 14 to the terminal corresponding to the guardian 12 to induce the guardian 12 to participate in the exhibition, and transmit the advertising effect of participating in the exhibition and the estimated number of people who participate in the exhibition to the terminal of the seller or manufacturer of the product and service to induce positive event participation.

The participation ticket providing unit 139 recruits participants in the exhibition among the registered sellers, and provides the guardian with a ticket for the exhibition. That is, the participation ticket providing unit 139 may recruit the sellers and manufacturers who provide the products or services according to the characteristics and purpose of the exhibition, and provide the guardian 12 registered as a member with the ticket for specific benefits of participation in the exhibition. Through this, the integrated animal management server 100 according to an embodiment of the present disclosure allows the sellers or manufacturers who provide the products or services to obtain various advertising effects through the exhibition, and the guardian to obtain various effects for the animal by participating in the exhibition.

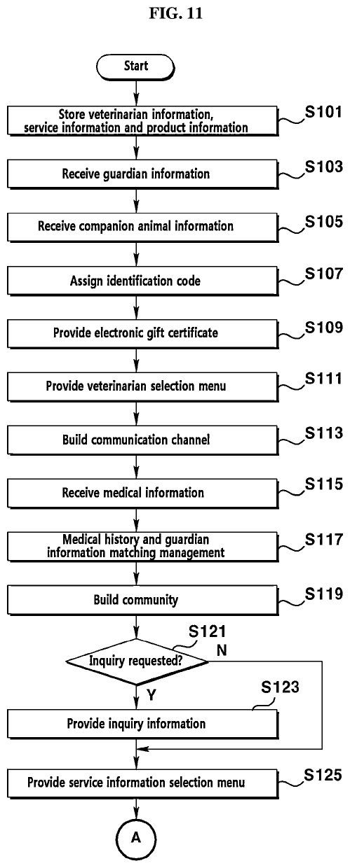

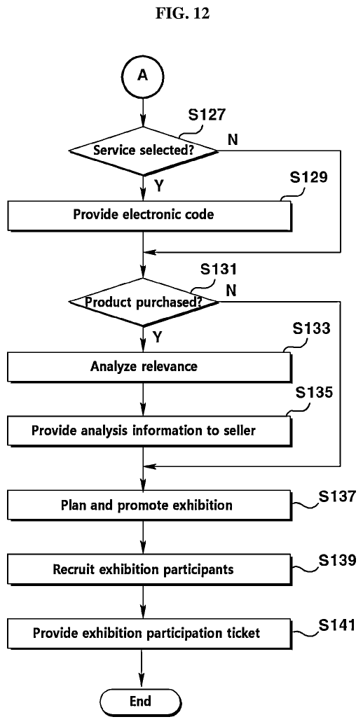

FIGS. 11 and 12 are flowcharts showing an integrated animal management method according to an embodiment of the present disclosure. The integrated animal management method according to an embodiment of the present disclosure may be performed by the integrated animal management server 100 shown in FIG. 2.

Referring to FIGS. 1 to 12, the integrated animal management server 100 stores the veterinarian information including at least one of treatment area or available time of the veterinarian 22 registered in the integrated animal management service according to an embodiment of the present disclosure (S101). In this instance, in addition to the treatment area and the available time of the registered veterinarian 22, the integrated animal management server 100 may store the veterinarian information about the career of the corresponding veterinarian 22, and the type of animal and the type of disorder or disease that the veterinarian 22 specializes.

Additionally, the integrated animal management server 100 stores the service information including service area and service time of at least one service of animal hotel, pet beauty shop or pet sitter. That is, the integrated animal management server 100 classifies and stores the service information including service area and service time of the company that offers the service such as animal hotel, pet beauty shop and pet sitter among the companies 30 registered in the integrated animal management service according to an embodiment of the present disclosure. Although it is described that the integrated animal management server 100 stores the information about the animal hotel, pet beauty shop and pet sitter as the service information for the animal, the integrated animal management server 100 may store the service information of various services for the animal 14.

Additionally, the integrated animal management server 100 receives and stores the product information from the seller who sells the product including at least one of insurance product, vaccine product, beauty product or feed product for the animal 14. That is, the integrated animal management server 100 receives and stores the product information of the product dealt with by the seller or manufacturer who deals with the product, for example, insurance product, vaccine product, beauty product and feed product for the animal among the registered companies 30 from the corresponding seller or manufacturer. In this instance, the integrated animal management server 100 may display the product information received from the seller or manufacturer on the web page to allow the guardian 12 to purchase the displayed product.

In this instance, the integrated animal management server 100 may store not only the product information or the service information of the product or service for the animal 14 but also the seller or manufacturer who sells the product or service. That is, the integrated animal management server 100 may store the information about the product or service for the animal 14 together with information about each seller or manufacturer among the companies 30 registered in the integrated animal management service according to an embodiment of the present disclosure.

The integrated animal management server 100 receives the guardian information including at least one of name, address, birthday or gender of the guardian from the guardian 12 who signed up the integrated animal management service according to an embodiment of the present disclosure (S103). In this instance, the integrated animal management server 100 may perform an authentication procedure on the received guardian information through certificate-based authentication or mobile authentication of the guardian 12.

The integrated animal management server 100 receives and stores the animal information including at least one of type, gender, picture or birthday of the animal 14 corresponding to the guardian 12 from the guardian 12 (S105). For example, the integrated animal management server 100 may receive and store animal type information of the animal 14 corresponding to the guardian 12, for example, a dog, a cat or any other type of animal. Additionally, the integrated animal management server 100 may receive and store breed information in the animal type information of the animal 14. For example, when the animal 14 is a dog, the integrated animal management server 100 may receive and store information about which the corresponding animal 14 is Maltese, Pomeranian or Chihuahua. Additionally, the integrated animal management server 100 may receive and store information about gender, picture, color, physical features, name called by the guardian 12 and birthday of the animal 14.

The integrated animal management server 100 assigns each identification code to the guardian 12 and the animal 14 corresponding to the guardian 12 (S107). In this instance, when the number of animals corresponding to the guardian 12 is more than one, the integrated animal management server 100 assigns different identification code to each animal. Additionally, in case that the animal is adopted, the integrated animal management server 100 assigns a new identification code to the adopter.

The integrated animal management server 100 provides the guardian 12 with the electronic gift certificate including at least one of treatment or vaccination for the animal 14 corresponding to the animal information received from the guardian 12 and stored (S109). In this instance, the integrated animal management server 100 may receive a preset membership fee from the guardian 12 who signed up the integrated animal management service according to an embodiment of the present disclosure, and in exchange for the membership fee, may provide the electronic gift certificate that can be used to purchase services, for example, treatment, vaccination, grooming, pet sitters and staying in animal hotels for the animal 14, or products, for example, feeds, toys, beauty products and medications.

The integrated animal management server 100 provides the guardian 12 with the selection menu for the veterinarian information (S111). In this instance, the integrated animal management server 100 may classify the veterinarian information of the veterinarian 22 registered in the integrated animal management service according to an embodiment of the present disclosure according to the treatment area, and display the veterinarian information in the order of distance from the address or the current location of the guardian 12. Through this, when an emergency situation happens to the animal 14, the guardian 12 may search for the veterinarian 22 near the current location of the guardian 12 to obtain rapid treatment for the animal 14.

Additionally, the integrated animal management server 100 may classify the veterinarian information of the registered veterinarian 22 according to the type of animal and the type of disorder or disease that the veterinarian 22 specializes in the treatment, and provide the corresponding selection menu. In this instance, when the guardian 12 selects any one veterinarian information corresponding to the provided selection menu, the integrated animal management server 100 may display detailed information about the selected veterinarian information. In this case, the integrated animal management server 100 may also display whether or not the veterinarian 22 corresponding to the veterinarian information selected by the guardian 12 can build a communication channel now.

When the guardian 12 requests to build the communication channel with the corresponding veterinarian 22 based on the selected veterinarian information, the integrated animal management server 100 builds the communication channel between the veterinarian 22 corresponding to the selected veterinarian information and the guardian 12 (S113). In this instance, the integrated animal management server 100 may build the communication channel for chatting between the guardian 12 and the veterinarian 22 to allow the guardian 12 to ask the likelihood of developing disorders or diseases caused by symptoms or conditions of the animal 14 and receive an appropriate and rapid response from the veterinarian 22. Although it is described that the integrated animal management server 100 builds the communication channel for chatting, in addition to the chatting channel, the integrated animal management server 100 may build various communication channels including an audio channel and a video channel.

The integrated animal management server 100 receives the medical information about at least one of treatment, surgery, vaccination or prescription for the animal corresponding to the electronic gift certificate provided to the guardian 12 (S115). That is, when the guardian 12 has treatment, surgery, vaccination and prescription for the animal 14 from the veterinarian 22 using the electronic gift certificate received from the electronic gift certificate providing unit 105, the integrated animal management server 100 receives the medical information about the treatment, surgery, vaccination and prescription conducted on the corresponding animal 14 from the veterinarian 22.

The integrated animal management server 100 manages the medical history of the animal 14 by matching it with the guardian information according to the medical information received from the veterinarian 22 (S117). That is, when the medical information of the animal 14 is received from the terminal of the veterinarian 22 via the network 2, the integrated animal management server 100 manages the corresponding medical information by matching it with the guardian information of the guardian 12. In this instance, the integrated animal management server 100 matches the identification code assigned to the previous guardian and the identification code assigned to the adopter with the identification code assigned to the animal 14 and manages the same. Additionally, when the number of animals 14 owned by the guardian 12 is more than one and each animal 14 has a parent, brother, sister relationship, the integrated animal management server 100 matches the identification code assigned to each animal 14, the identification code of the animal 14 in a parent, brother, sister relationship and the identification code assigned to the guardian 12 and manages the same.

For example, when guardian 1 owns animal 1, animal 2 and animal 3 and animal 2 and animal 3 have a parent, brother, sister relationship, the integrated animal management server 100 may, for animal 1, match the identification code of guardian 1 with the identification code of animal 1 and manage the same, and for each of animal 2 and animal 3, match the identification code of guardian 1, the identification code of the corresponding animal (animal 2 or animal 3) and the identification code of the other animal in a parent, brother, sister relationship (for animal 2, animal 3, and for animal 3, animal 2) and manage the same. In this instance, when the adopter adopts animal 2 among animal 2 and animal 3 in a parent, brother, sister relationship, the integrated animal management server 100 may, for animal 2, match the identification code of the previous guardian 1, the identification code of the adopter, the identification code of animal 2 and the identification code of animal 3 and manage the same.

As described above, when the animal is adopted from any one guardian to another guardian, the guardian information-based integrated animal management server 100 according to an embodiment of the present disclosure may clearly identifying an adoption history of the animal by matching the identification code of the previous guardian and the identification code of the adopter together with the identification code of the corresponding animal and managing the same.

Additionally, since the guardian information-based integrated animal management server 100 according to an embodiment of the present disclosure manages the identification code of any one animal together with the identification code of the animal having parent, brother, sister relationship with the corresponding animal, in case that the animal in a parent, brother, sister relationship is adopted by another guardian, it is possible to identify the adopter through the identification code of the adopted animal, and ensure rapid cooperation between the animals in a parent, brother, sister relationship when the animal has genetic disorders or diseases.

The integrated animal management server 100 may build the community with at least one other registered guardian in response to the request from the guardian 12 or induce participation in the built community (S119). In this instance, to make it easy to build the community, the integrated animal management server 100 may make information accessible to guardians registered as members, for example, the types of animals of the guardians, the number of members corresponding to each type, the breed of each animal and the number of members corresponding to each breed. Additionally, the integrated animal management server 100 may make information accessible to the members, for example, the types of animals and the breeds of animals in the built community. For example, in the case of the community for guardians who own a specific breed of pet dog, the integrated animal management server 100 may make information accessible to the members, for example, the breed of the corresponding pet dog and the number of members in the community, to allow the guardian 12 who owns the animal 14 of the same breed to exchange opinions about treatment, vaccination and grooming for each animal 14 with the other members.

When the request for inquiry about the specific animal 14 is received from a third party (S121), the integrated animal management server 100 provides the third party with the inquiry information including the animal information and the medical history of the corresponding animal 14 (S123). For example, when the specific guardian 12 wants to participate in the built community, the corresponding community manager may request to inquire about the animal 14 of the specific guardian 12 who wants to participate, and in this case, the integrated animal management server 100 may provide the corresponding community manager with the inquiry information including guardian, type, breed, birthday and medical history of the animal 14 of the specific guardian 12.

Additionally, the adopter who wants to adopt the animal 14 from the specific guardian 12 may request to inquire about the corresponding animal 14, and in this case, the integrated animal management server 100 may provide the adopter with the animal information and the medical history of the animal 14 of the specific guardian 12. In this instance, when the integrated animal management server 100 provides the third party with the animal information of the specific guardian, the integrated animal management server 100 may allow the third party to see only brief information such as ID and name of the specific guardian, and may encode or omit personal information of the specific guardian.

Through this, the integrated animal management server 100 according to an embodiment of the present disclosure allows the members to check the animal information and the medical history of the animal freely, thereby verifying the authenticity of the animal of the member who wants to participate in the specific community and checking treatment and vaccination in the case of fostering or adoption of the animal between the members.

The integrated animal management server 100 provides the guardian 12 with the selection menu for the stored service information (S125). In this instance, the integrated animal management server 100 may provide the type of the stored service as the selection menu, and provide each service corresponding to the type of the selected service as the additional selection menu. In this case, each additional selection menu may be classified according to the company and service area of the corresponding service.

When the guardian 12 selects the service information corresponding to the provided selection menu (S127), the integrated animal management server 100 provides the electronic code corresponding to the selected service information (S129). In this instance, the integrated animal management server 100 may subtract money corresponding to the selected service information from money paid by the guardian 12 when signing up or additional money paid, and provide balance information to the guardian 12. Additionally, the integrated animal management server 100 may provide the electronic code available for any service anywhere irrespective of area and service by the selection of the guardian 12 or the electronic code available only for a designated specific service.

When the guardian 12 purchases at least one product in the product information displayed on the web page (S131), the integrated animal management server 100 analyzes the relevance between the animal information of the animal corresponding to the guardian 12 and the purchased product (S133). In this instance, the integrated animal management server 100 may sell each product corresponding to the product information received from the insurance provider, medication supplier, beauty products supplier and feed supplier on behalf, record the type, breed, gender and birthday of the animal corresponding to the guardian 12 who purchased for each product, accumulate data recorded for each product purchased for the set period of time, and analyze the number of sales for each product, the time at which the specific product is sold, and the gender and age of the animal for which the specific product is popular, according to the type, breed, gender and birthday of the animal, through the accumulated data.

The integrated animal management server 100 provides the seller or manufacturer with the analysis information analyzed for the set period of time (S135). That is, the integrated animal management server 100 provides the analysis information about the number of sales of the product for the set period of time and the type, breed, gender and birthday of the animal 14 of the guardian 12 who usually purchases the product for each product corresponding to the product information received from the seller or manufacturer.

Through this, the manufacturer or seller of the product may gradually create advanced sales strategies and improvement measures for his/her product.

The integrated animal management server 100 plans the exhibition for the animal 14, and promotes the planned exhibition (S137). That is, the integrated animal management server 100 may hold the exhibition in which the insurance provider, medication supplier, beauty products supplier, feed supplier and pet beauty shop may participate, to promote the sales of the product or service of the insurance provider, medication supplier, beauty products supplier, feed supplier and pet beauty shop who participates in the exhibition and help the guardian 12 who participates in the exhibition to manage the animal 14 to look better and be healthier, thereby activating animal management. In this instance, the integrated animal management server 100 may transmit the event duration and details of the planned exhibition and benefits for the animal 14 to the terminal corresponding to the guardian 12 to induce the guardian 12 to participate in the exhibition, and transmit the advertising effect of participating in the exhibition and the estimated number of people who participate in the exhibition to the terminal of the seller or manufacturer of the product and service to recruit participants in the exhibition and induce positive event participation.

The integrated animal management server 100 recruits participants in the exhibition among the registered sellers (S139), and provides the guardian with a ticket for the exhibition (S141). That is, the integrated animal management server 100 may recruit the sellers and manufacturers who provide the products or services according to the characteristics and purpose of the exhibition, and provide the guardian 12 registered as a member with the ticket for specific benefits of participation in the exhibition.

Through this, the integrated animal management server 100 according to an embodiment of the present disclosure allows the sellers or manufacturers who provide the products or services to obtain various advertising effects through the exhibition, and the guardian to obtain various effects for the animal by participating in the exhibition.

While the embodiments according to the present disclosure have been hereinabove described, this is provided by way of illustration, and those skilled in the art will understand that a variety of modifications and equivalents may be made thereto. Accordingly, the scope of protection of the present disclosure should be defined by the appended claims and equivalents thereof.

According to the present disclosure, it is possible to rapidly identify animals without implanting microchips in the animals in the event of adoption or development of genetic disorders or diseases.

Additionally, according to the present disclosure, it is possible to provide various product or services for animals in an integrated manner and systematically manage the animals.

What is claimed is:

1. An integrated animal management server which is configured to manage animals and to be connected to terminals of guardians of the animals and terminals of adopters via a network to provide an integrated animal management service to members, the integrated animal management server comprising:
a guardian information receiver configured to receive guardian information of the guardians that sign up the integrated animal management service as members, perform an authentication procedure on the guardians, and register the guardian information;
an animal receiver configured to receive and store animal information including types and breeds of the animals of the guardians registered as the members;
a database configured to manage the guardians registered as the members and the animals of the guardians;
a medical history management processor configured to manage an adoption history when the animals are adopted between the members;
an identification code assigning processor configured to assign an identification code to each of the guardians registered as the members, the animals of the guardians and the adopters; and
an inquiry information providing processor configured to, when an inquiry request about a first animal among the animals managed by the integrated animal management service is received from the adopter who is the member of the integrated animal management service and desires to adopt the first animal, provide the adopter with the animal information including the type and breed of the first animal,
wherein the medical history management processor is configured to, when the first animal is adopted from a first guardian registered as the member of the integrated animal management service to the adopter registered as the member of the integrated animal management service, match the identification code of the adopter, the identification code of the first animal, the identification code of the first guardian and the identification code of at least one animal having a relationship of a father, mother, older brother, younger brother, older sister or younger sister with the first animal among the animals managed by the integrated animal management service and manage the same, and
wherein the animals managed by the integrated animal management server include at least one of companion animals, livestock or animals owned by owners.

2. The integrated animal management server according to claim 1, wherein the medical history management processor is configured to, when the first guardian owns the first animal and a second animal having the relationship of a father, mother, older brother, younger brother, older sister or younger sister with the first animal, for the first animal, match the identification code of the first guardian, the identification code of the first animal and the identification code of the second animal and manage the same.

3. The integrated animal management server according to claim 2, wherein the medical history management processor is configured to:
when the first guardian owns the first animal, the second animal and a third animal and the first animal and the second animal have the relationship of a father, mother, older brother, younger brother, older sister or younger sister,
for the first animal, match the identification code of the first guardian, the identification code of the first animal and the identification code of the second animal having the relationship of a father, mother, older brother, younger brother, older sister or younger sister with the first animal and manage the same,
for the second animal, match the identification code of the first guardian, the identification code of the second animal and the identification code of the first animal having the relationship of a father, mother, older brother, younger brother, older sister or younger sister with the second animal and manage the same, and
for the third animal manage, match the identification code of the first guardian and the identification code of the third animal and manage the same.

4. The integrated animal management server according to claim 1, wherein the integrated animal management server is configured to be connected to the terminals of the guardians, the terminals of the adopters and terminals of veterinarians via the network, and
wherein the integrated animal management server further comprises a medical information receiver configured to receive medical information of the animals of the guardians registered as the members from the registered veterinarians of the integrated animal management service.

5. The integrated animal management server according to claim 4, wherein the medical history management processor is configured to match the medical information with the guardian information and manage the same,
wherein the inquiry information providing processor is configured to, when the inquiry request about the first animal is received from the adopter, provide the adopter with the animal information including the type and breed of the first animal and the medical information of the first animal.

6. The integrated animal management server according to claim 2, wherein the medical history management processor is configured to match the identification code of the first guardian, the identification code of the first animal and the identification code of the second animal and manage the same, and when medical information of the first animal is received, match the medical information of the first animal with the guardian information of the first guardian and manage the same.

7. The integrated animal management server according to claim 1, wherein the livestock includes at least one of cattle or pigs, and
wherein the animals owned by the owners include parrots or turtles.

8. The integrated animal management server according to claim 1, further comprising:
a seller registration processor configured to register sellers who sell products or services for the animals;
an exhibition promoting processor configured to plan an exhibition for the animals and promote the planned exhibition; and
a participation ticket providing processor configured to recruit participants in the exhibition among the registered sellers and provide the guardians with tickets for the exhibition.

9. An integrated animal management method of an integrated animal management server which manages animals and is connected to terminals of guardians of the animals and terminals of adopters via a network to provide an integrated animal management service to members, the integrated animal management method comprising:
receiving guardian information of the guardians that sign up the integrated animal management service as members, performing an authentication procedure on the guardians, and registering the guardian information;
receiving and storing animal information including types and breeds of the animals of the guardians registered as the members;
when an inquiry request about a first animal among the animals managed by the integrated animal management service is received from the adopter who is the member of the integrated animal management service and desires to adopt the first animal, providing the adopter with the animal information including the type and breed of the first animal;
when the first animal is adopted from a first guardian registered as the member of the integrated animal management service to the adopter registered as the member of the integrated animal management service, matching identification code of the adopter, identification code of the first animal, identification code of the first guardian and identification code of at least one animal having a relationship of a father, mother, older brother, younger brother, older sister or younger sister with the first animal among the animals managed by the integrated animal management service and managing the same; and
managing an adoption history when the animals are adopted between the members,
wherein the animals managed by the integrated animal management server include at least one of companion animals, livestock or animals owned by owners.

10. The integrated animal management method according to claim 9, wherein the managing comprises:
when the first guardian owns the first animal and a second animal having the relationship of a father, mother, older brother, younger brother, older sister or younger with the first animal, for the first animal, matching the identification code of the first guardian, the identification code of the first animal and the identification code of the second animal and managing the same.
